(19) United States
(12) Patent Application Publication
(10) Pub. No.: US 2025/0097675 A1
(43) Pub. Date: Mar. 20, 2025

(54) SYSTEM AND METHOD FOR TESTING MESSAGE TEMPLATES

(71) Applicant: Gupshup Inc, FREMONT, CA (US)

(72) Inventors: Inderpal Singh Mumick, Berkeley Heights, NJ (US); Surinder Singh Anand, Highland, NJ (US); Manivannan Arunachalam, Bangalore (IN)

(21) Appl. No.: 18/885,660

(22) Filed: Sep. 15, 2024

Related U.S. Application Data
(60) Provisional application No. 63/582,856, filed on Sep. 15, 2023.

(51) Int. Cl. H04W 4/14

(52) U.S. Cl. CPC H04W 4/14

(57) ABSTRACT

A method for creating and testing a rich message template are provided. The method provides a rich message template management application (RMTMA) to create and test a message template by sending a rich message conforming to a template definition.

### CROSS-REFERENCE TO RELATED APPLICATIONS

This application claims priority to and the benefit of the provisional patent application titled “System And Method For Testing Message Templates”, application No. 63/582,856, filed in the United States Patent and Trademark Office on Sep. 15, 2023. The specification of the above referenced patent application is incorporated herein by reference in its entirety.

### BACKGROUND

Several rich messaging channels, such as rich communication services (RCS), WhatsApp® of WhatsApp LLC, etc., support rich business messaging allowing businesses to engage in two-way rich business messaging with users. communication providers, such as Meta (for WhatsApp), Google, Dotgo, Mavenir, and various carriers (for RCS), provide platforms with online portals and application programming interfaces (APIs) to allow developers to send rich business messages to users using APIs and tools such as a campaign manager.

Some of these platforms, such as Meta's platform for WhatsApp and Google's Google Jibe platform for RCS, send and receive messages to and from users over a data channel. Other platforms, on the other hand, may send the messages to another communication platform such as Google Jibe for RCS, which in turn will send the message to the user.

The communication providers also have a process for verifying a business and a process of launching its sender identity (ID) before the business can send messages to users globally or in selected countries and carriers. For example, messaging channels, such as WhatsApp®, has a process for verifying and launching a WhatsApp® sender i.e., a phone number, on a global basis. Similarly, RCS messaging channels have a process for verifying and launching an RCS sender i.e., rich business messaging (RBM) agent, on a per-country or per-carrier basis. Additionally, some communication channels may also support a process for adding testers in the form of mobile station international subscriber directory numbers (MSISDNs), that are whitelisted to allow test messages to be sent and received even before the sender of the business has been verified and launched.

Some rich business messaging channels also support the concept of message templates. Furthermore, communication providers define certain rules regarding the types of messages businesses are permitted to send. An example of such a rule is that businesses are only allowed to send messages that conform to an approved message template, unless the user is already engaged in a “conversation” with the business. The definition of a conversation can vary from one messaging channel to another, and in some cases may depend on the communication provider or the carrier. One example of a conversation is when a user sends a message to a business, either in response to a message from the business or on its own, which starts a conversation window for a specified conversation period, for example, for 24 hours. In some cases, the conversation window closes at 24 hours or the configured value after the user's first message. In other cases, the conversation window gets extended each time the user sends another message and is a rolling 24 hour period from the user's last message. An example of another rule might limit the number of messages a business is allowed to send, such as a maximum of “X” number of messages in a month or “Y” number of messages in a week, with additional messages being permitted if a user responds or sends an unsolicited person-to-application (P2A) message to the business. An example of another rule is that a business may be restricted to sending messages only during designated “business hours”, such as from 10 am to 8 pm.

The communication providers offer tools for creating message templates through their portal and/or using a Template Management API. These tools enable businesses and their developers to create templates and submit them for approval. Both the portal and the Template Management APIs may support methods to create, list, view, delete, modify, submit for approval, and view status of templates. Each template created on the communication provider's platform is assigned a template ID. The communication provider defines rules to ensure that a template can be uniquely identified by a combination of template ID and the sender ID of the business. In another embodiment, the communication provider may defines rules to ensure that a Template can be uniquely identified by its template ID alone. Some of the message templates may also support custom variables, which can be substituted by values specified for each recipient i.e., a user's MSISDN.

Furthermore, the communication provider supports specialized Send Template Message APIs for sending Template Messages, in addition to the Send Message APIs used for sending various types of messages, for example, text, rich card, rich card carousel, file, list view, suggested reply and suggested action buttons, or quick reply buttons. The Send Template Message API takes the template ID (and sender ID), the MSISDN of the recipient, and a list of values of the custom variables defined for the template.

However, there is a need for businesses to test these templates by sending template messages to test users before submitting the templates for approval. There is also a need to support test messages that do not adhere to business rules. For example, during testing, it is expected that a large number of messages will be sent in a short time to the same test number, a behavior that would typically be considered as spam but is permissible while testing. In another example, during testing, it can be expected that messages will be sent in the evening or at night, which is usually not permitted for promotional messages but is desired while testing.

Communication providers may also provide tools on their online portal to test template messages. This requires the platform to allow businesses to send template messages to users even when the user is not actively engaged in a conversation. This is accomplished by implementing special processing on the platform that bypasses the Send Template Message API and send the underlying message directly to the user. In some cases, the underlying message may be sent to a communication channel that does not enforce the rules related to message templates. An example of this scenario is the Dotgo platform that enforces rules related to message templates, and sends them to users via the Google Jibe platform, which does not recognize the templates and does not enforce any rules related to Template Messages.

Furthermore, there are communication platform as a service (CPaaS) providers who have their own platforms and connect to the platforms of the business messaging communication providers. The CPaaS providers provide their own platforms to their business users and/or developers access to an online portal and APIs. These can include online tools and APIs for sending messages, including Template Messages, and for creating and managing message templates. Additionally, the platform of the CPaaS provider can also use Template Management APIs of the communication provider to create and manage message templates.

However, the communication platform as a service (CPaaS) providers cannot implement features on their platform to test message templates before they are approved, or to bypass the business rules. If CPaaS providers call the Send Template Message API on the communication provider's platform, the request will be rejected because the Template has not been approved. If CPaaS providers send the message using the underlying Send Message API, the request will be rejected because the user is not engaged in a conversation with the business.

Hence, there is a long felt need for a method and system to allow communication platform as a service (CPaaS) providers and other developers to test message templates from their platform.

### SUMMARY OF THE INVENTION

This summary is provided to introduce a selection of concepts in a simplified form that are further disclosed in the detailed description of the invention. This summary is not intended to determine the scope of the claimed subject matter.

The methods and system disclosed herein address the above-recited need for communication platform as a service (CPaaS) providers and other developers to test one or more message templates from their platforms. As used herein, the term “message template”, refers to message formats for reusable messages that a business may want to send to a user, i.e., an intended recipient. message templates may also include optional custom variables that can be replaced by value(s) for each user when sending the message. Also, as used herein, the term “template message” refers to a message sent to a user using a “message template” and custom value of optional variable. Also, as used herein, “test message template” refers to the process of sending template messages to one or more testers for review. Furthermore, the Template Messages are sent to users who are in a conversation or those who have not been in communication with the business before or who have not replied to an existing chat since at least 24 hours. Also, as used herein, the term “tester” refers to one of a verified individual, a device, a number, a phone number associated with a device, etc., who has been authorized to receive, review, and evaluate message templates before they are approved for sending to the general public.

The method and the system for a communication platform as a service (CPaaS) Provider to test a message template is disclosed. The method and the system employ a rich message template management application (RMTMA) in a non-transitory, computer-readable storage medium communicatively coupled to at least one processor. The non-transitory computer-readable storage medium is configured to store computer program instructions executable by the at least one processor. The computer program instructions, when executed by the at least one processor, cause at least one processor to manage actions associated with testing message templates. The CPaaS provider creates the message template on a communication provider's platform using one of a user interface (UI) tool, or a “Template Management” application programming interface (“Template Management API”) provided by a communication provider. The created message template is tagged with a unique template ID and a sender ID. A business user or a developer adds a Mobile Station International Subscriber Directory Number (MSISDN) of an intended recipient i.e., a user, as a tester on the communication provider's platform. The CPaaS provider's platform sends a request to the communication provider's platform to send a test template message to the intended recipient, using a “Send Test Template Message” application programming interface (“Send Test Template Message API”) provided by the communication provider. The communication provider's platform verifies that the intended recipient is a valid tester. If the MSISDN is a valid tester, the communication provider's platform retrieves a definition of the message template based on the unique template ID, the sender ID, and values of custom variables. The communication provider's platform expands the message template to create the test template message into an underlying rich message for a channel and sends it to the intended recipient via a Channel Platform using the “Send Channel Message API” of the Channel Platform. The CPaaS provider's platform receives a confirmation from the intended recipient that the test template message is as per expectation. The Send Message API on the communication provider's platform is likely to be similar to the Send Channel Message API on the Channel Platform in terms of the functionality, whereas the syntax of these two APIs may be the identical, similar or different. The difference between these two APIs is that the Send Message API is supported on the communication provider's platform whereas the Send Channel Message API is supported on the channel platform.

In another embodiment, a method for CPaaS Providers to test message templates from their platform is based on a communication provider providing a “Send Test Message” application programming interface (“Send Test Message API”) for sending a message to a Tester, even when the Tester is not engaged in a conversation. The CPaaS provider creates a message on the communication provider's platform, The CPaaS provider adds Mobile Station International Subscriber Directory Number (MSISDN) of an intended recipient i.e., a user, as a tester on the communication provider's platform. The CPaaS provider sends a request to the communication provider's platform using the “Send Test Message API” to send the message to the intended recipient. The communication provider's platform verifies that the intended recipient is a valid tester and sends the message to the intended recipient using the “Send Channel Message API” of the channel platform. The CPaaS Provider uses the “Send Test Message API” to send test messages to the tester, even when the tester is not engaged in a conversation.

In another embodiment, a method for CPaaS Providers to test message templates from their platform is based on the CPaaS Provider's platform creating one or more Special message templates on the communication provider's platform, submitting them for pre-approval, and sending the initial message to the intended recipient i.e., the, user using one of the Special message templates. This method can be implemented by a CPaaS provider without the need of any special support from the communication provider.

In another embodiment, a method for CPaaS Providers to test message templates from their platform is based on the communication provider providing a “Send Fixed Test Message” application programming interface (“Send Fixed Test Message API”) for sending one of a set of Fixed Test Messages to a Tester, inviting the Tester to initiate testing, even when the Tester is not engaged in a Conversation. The CPaaS provider adds Mobile Station International Subscriber Directory Number (MSISDN) of a user (intended recipient) as a tester on the communication provider's platform. The CPaaS provider sends a request to the communication provider's platform to send the test message to the intended recipient. The CPaaS Provider sends a request to the communication provider's platform to send a fixed test message to the tester i.e., intended recipient, to initiate testing. The communication provider's platform verifies that the intended recipient is a valid tester and sends the fixed test message to the intended recipient using the “Send Fixed Test Message API”. The tester then responds in the affirmative by sending a person-to-application (P2A) message or by clicking on a suggested reply button, thus starting a conversation, following which the CPaaS Provider's platform sends the Template Message to the tester using the “Send Message API” provided by the communication provider.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific methods and components disclosed herein. The description of a method step or a component referenced by a numeral in a drawing is applicable to the description of that method step or that component shown by that same numeral in any subsequent drawing herein.

FIG. 1 (Prior Art) illustrates screenshot of a graphical user interface rendered on the CPaaS Provider's platform to add tester.

FIG. 2 illustrates a flowchart of a first method for a communication platform as a service (CPaaS) Provider to test a message template.

FIG. 3 illustrates a flowchart of a second method for a communication platform as a service (CPaaS) Providers to test message templates from their platform.

FIG. 4 illustrates a flowchart of a third method for a communication platform as a service (CPaaS) Providers to test message templates from their platform.

FIGS. 5A-5B illustrates a flowchart of a fourth method for a communication platform as a service (CPaaS) Providers to test message templates from their platform is disclosed.

FIG. 6 exemplarily illustrates an architectural block diagram of an exemplary implementation of a CPaaS provider's platform for testing a message template is provided.

FIGS. 7A-7B illustrate screenshots of a graphical user interface displaying fixed text messages.

FIG. 8 illustrates screenshot of a graphical user interface displaying options to select test devices and MSISDN of the selected test device to Test Templates.

FIG. 9 illustrates screenshot of a graphical user interface displaying options to send test messages for the selected template.

FIGS. 10A-10B illustrate screenshots of a graphical user interface displaying status of the test message sent to the selected test device.

FIG. 11 exemplarily illustrates a schematic showing a process flow of an embodiment of the method for communication platform as a service (CPaaS) Provider to test a message template on a CPaaS Provider's platform via rich communication services (RCS) channel.

FIG. 12 exemplarily illustrates a schematic showing a process flow of an embodiment of the method for communication platform as a service (CPaaS) Provider to test a message template on a CPaaS Provider's platform via WhatsApp channel.

### DETAILED DESCRIPTION OF THE INVENTION

Various aspects of the disclosure herein are embodied as a system, a method, or a non-transitory, computer-readable storage medium having one or more computer readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

A communication provider is an entity that runs and manages a platform that offers business messaging services across various communication channels, such as rich communication services (RCS), WhatsApp®, Viber® of Viber Media SARL, and SMS to businesses, developers, and communication platform as a service (CPaaS) Providers. The communication provider has the authority to define and enforces the policies and rules to be followed by businesses when creating a sender identity (sender ID) for the business and sending messages to users. In many cases, multiple organizations may collaborate to play the role of the communication provider. A common example would be a Technology and Service Provider partnering with a channel platform. Another example would be the channel platform itself. Another example would be a Technology and Service Provider collaborating with one or more Carriers such as, Mobile Network Operators, who in turn partner with a Channel Partner. Another example would be a Carrier such as, Mobile Network Operators, partnering with the Channel Partner, to play the role of a communication provider for the channel.

A channel platform is a system that manages and facilitates the delivery of communication services for a specific channel, such as SMS, email, voice, RCS, WhatsApp Facebook Messenger and Signal. The channel platform interfaces with various networks and services, routes messages to their destinations, and often provides APIs for external systems to send and receive messages. The channel platform ensures efficient and reliable communication by handling message management, monitoring, and customization for the channel. For the channel SMS, the role of the channel platform can be fulfilled by a Short Message Service Center (SMSC) being operated and managed by a Mobile Network Operator (MNO). For the channel email, the role of the channel platform can be fulfilled by a Simple Mail Transfer Protocol (SMTP) Server operated and managed by an Internet Service Provider. For the channel RCS, the role of the channel platform can be fulfilled by an RCS Application Server and a Messaging as a Platform (MaaP) operated and managed by a Mobile Network Operator (MNO) or by a technology partners such as Google Jibe operating and managing it on behalf of the MNO. For the channel WhatsApp Business Messaging, the role of the channel platform is fulfilled by the WhatsApp application and servers operated and managed by Meta. In an embodiment, a channel platform can manage and facilitates the delivery of communication services for multiple channels.

For the rich communication services (RCS) channel, the role of a communication provider can be fulfilled by Google, which operates the RCS Channel platform such as, Google Jibe RBM platform. In an embodiment, the role of the communication provider can be played by another Technology Provider, for example, Dotgo, who operates the Dotgo RBM Hub and MaaP (at developer.dotgo.com). In yet another embodiment, the role a communication provider can be played jointly by a Technology Provider and a Carrier. In yet another embodiment, the role a communication provider can be played by a Carrier, for example, Orange. In some cases, the role of a communication provider may be split between two communication providers who verify and enforce different business rules.

For the WhatsApp channel, the role of a communication provider can be played by Meta, who operates the WhatsApp channel. In an embodiment, the role of the communication provider can be played by another Technology Provider, for example, a Business Solutions Provider (BSP) like Dotgo, who offers WhatsApp Business API to other CPaaS Providers. In some cases, the role of a communication provider may be split between two communication providers who verify and enforce different business rules.

A communication platform as a service (CPaaS) Provider is an entity that runs and manages a platform to offer business messaging services on one or more communication channels, such as SMS, RCS, WhatsApp and Viber, to businesses, developers, and other CPaaS Providers. A CPaaS Provider needs to provides tools to help their customers follow the policies and rules defined by the communication providers of the respective business messaging channels supported by the CPaaS Provider. This may include enforcement of the policies and rules on its own platform before sending the requests to the communication provider's platform.

In the present application, it is possible that the role of communication provider could be fulfilled by the channel platform. In such a case, the steps ascribed to the communication provider in the present application, would be done by the channel platform.

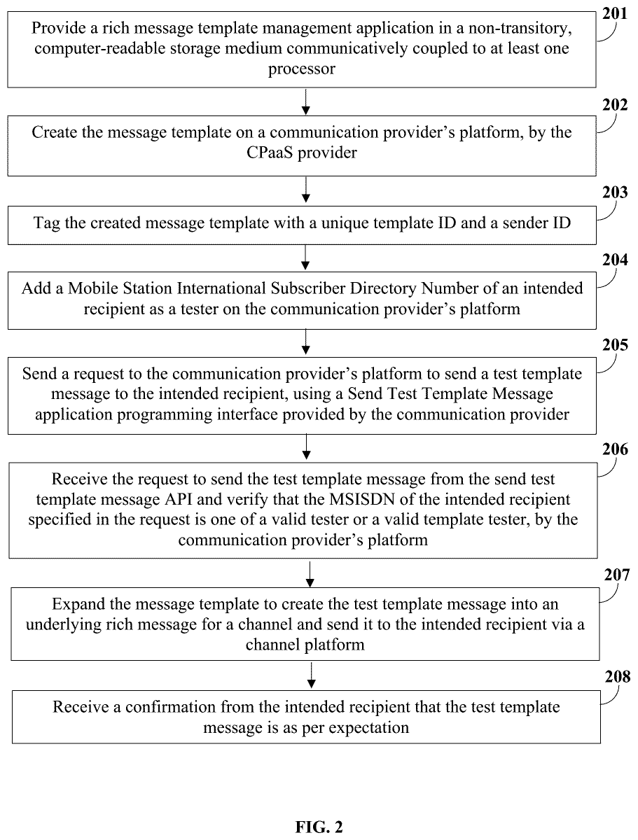

FIG. 2 illustrates a flowchart of a first method for a communication platform as a service (CPaaS) Provider to test a message template. The CPaaS provider allows a business user or a developer to create a message template on the CPaaS Provider's Platform. As used herein, the term “business” refers to an enterprise or an organization, that sends one or more of notifications, promotional messages, transactional messages, etc., to a user's mobile number to inform the user about transactions, coupons, promotions, news, updates, emergencies, etc. The method employs a rich message template management application (RMTMA) 201 in a non-transitory, computer-readable storage medium communicatively coupled to at least one processor. The non-transitory computer-readable storage medium is configured to store computer program instructions executable by the at least one processor. The computer program instructions, when executed by the at least one processor, cause at least one processor to manage actions associated with testing message templates.

The CPaaS provider creates 202 the message template on a communication provider's platform using one of a user interface (UI) tool, or a “Template Management” application programming interface (“Template Management API”) provided by a communication provider. In an embodiment, the CPaaS provider enables the business user or developer to create the message template directly on the CPaaS provider's platform. The CPaaS provider's platform creates an equivalent message template on the communication provider's platform using one of a User Interface (UI) tool, or by sending a request via the “Template Management API” to the communication provider's platform. The input parameters of the Template Management API includes: 1) a template identifier (ID) which is uniquely identified on the communication provider's platform. In an embodiment, this identifier includes template ID and, optionally, sender ID and/or Account ID of a business user or developer; 2) a Mobile Station International Subscriber Directory Number (MSISDN) of an intended Recipient; 3) value of custom variables, can be provided optionally, if defined in message template. For example, the values of custom variables can be specified in the form of a name-value pair in a format such as JavaScript Object Notation (JSON) or Extensible Markup Language (XML). For example, the values of custom variables can also be specified as a sequence (or list) of values, where each value maps to a specific custom variable in the message template.

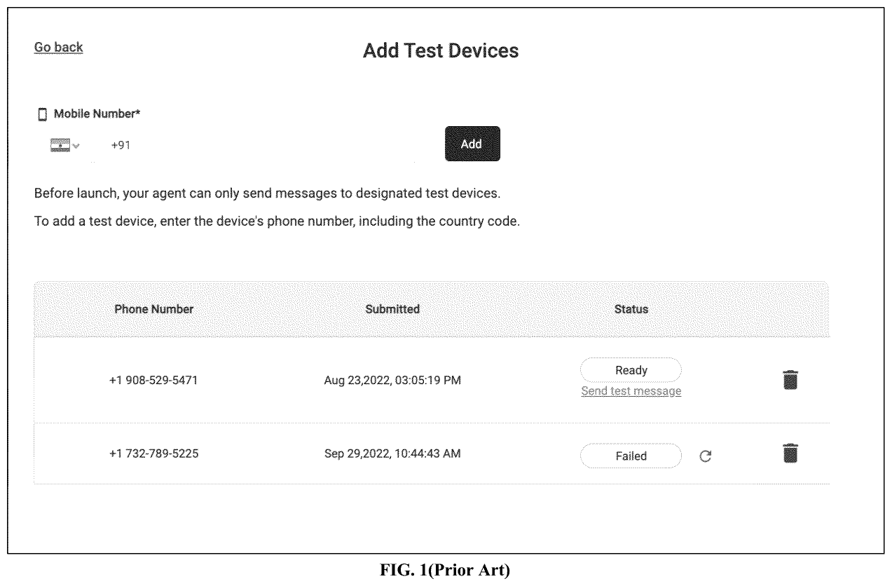

The created message template is tagged 203 with a unique template ID and a sender ID. The business user or developer adds 204 the Mobile Station International Subscriber Directory Number (MSISDN) of the intended recipient i.e., a user, as a tester on the communication provider's platform. For example, the business user or developer uses the ‘Add Tester’ feature on the CPaaS provider's platform to add an intended recipient's MSISDN as a Tester by entering the intended recipient's mobile number i.e., MSISDN, and clicking add to add a tester, as exemplarily illustrated in FIG. 1 (Prior art). The CPaaS provider's platform sends the request to add a Tester to the communication provider's platform. Depending on the specific channel, there is a process to make the MSISDN as a Tester. In another example, for rich communication services (RCS) channel, the intended recipient' MSISDN will receive a Tester Invite, and the intended recipient becomes a Tester upon accepting the Tester Invite. In another example, the CPaaS provider's platform and the communication provider's platform implement a Test Template Tester feature to add an intended recipient's MSISDN as a Template Tester, distinct from being a Tester who can receive a message from an RCS Sender that has not been verified and launched. In another example, in order to become a tester on WhatsApp, the user may need to send a message to a sandbox number to emulate communication with the sender ID of the business. In another example, users can register to become testers in various ways depending on the channel platform they choose. In another embodiment, the communications platform sends a message from an RCS agent to the user i.e., recipient, asking if they want to become a tester. If the user agrees, the communications platform can then send all messages, including those from non-approved templates, to the user.

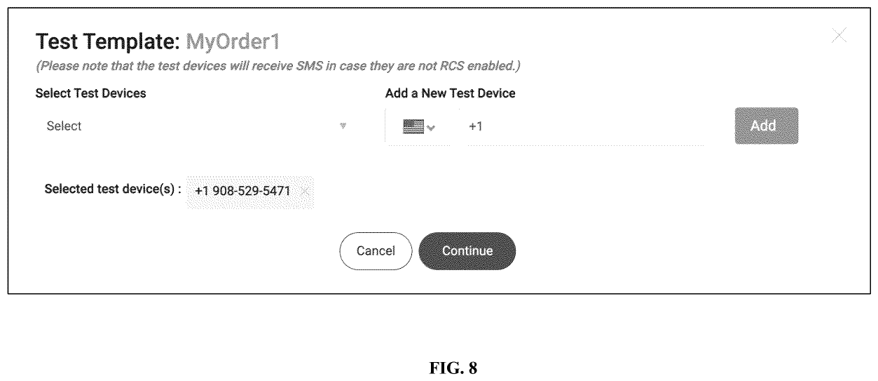

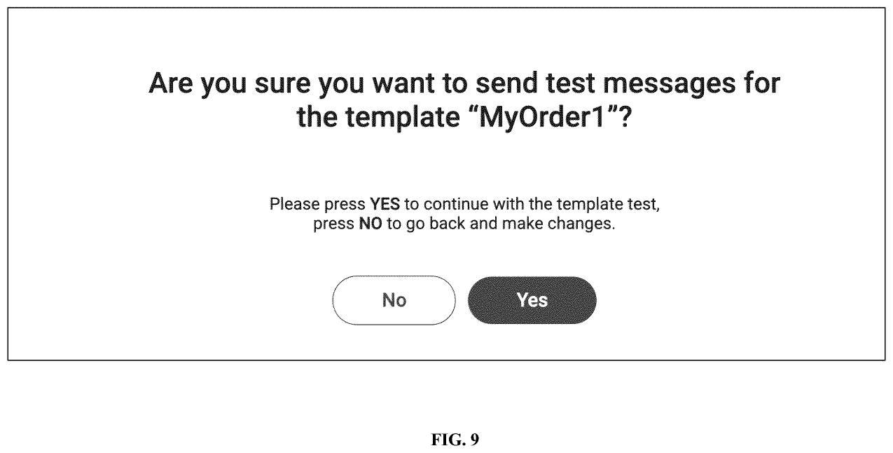

The CPaaS provider's platform includes a feature that allows the business users or developers to Test Templates by selecting the created message template and specifying the MSISDN of the intended recipient, and optionally the value(s) of the custom variables, if any. For example, to test a test template “MyOrder1” the business users or developers selects the option “Select Test Devices” and adds the MSISDN i.e., mobile number, of the intended recipient before selecting the option “Continue”, as exemplarily illustrated in FIG. 8. Following the selection of continue, a graphical user interface displaying options “No” and “Yes”, to send test messages for the selected template “MyOrder1” is displayed to the business users or developers, as exemplarily illustrated in FIG. 9. In an embodiment, the CPaaS provider's platform may or may not verify that the specified or selected MSISDN is a valid Tester for that channel and the sender ID of the Business.

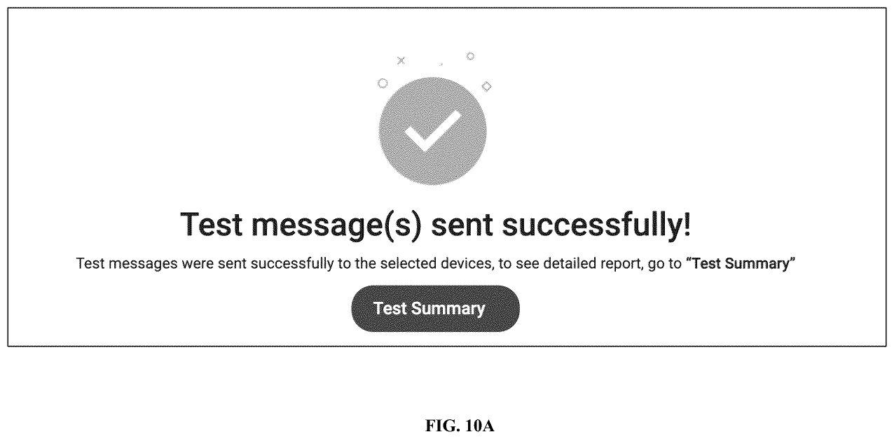

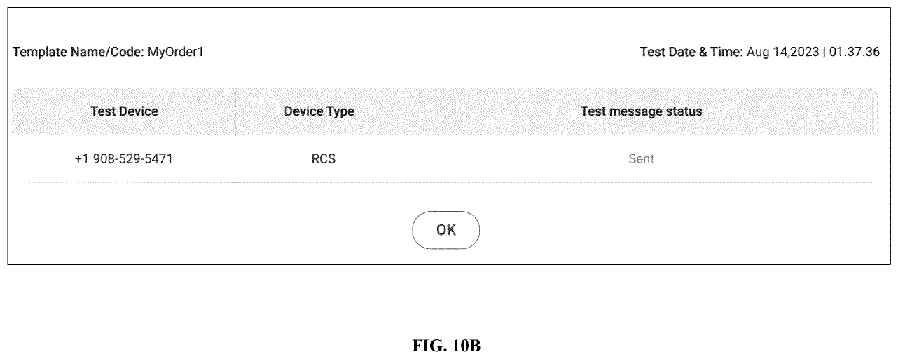

The CPaaS provider's platform sends 205 a request to the communication provider's platform to send a test template message to the intended recipient, using a “Send Test Template Message” application programming interface (“Send Test Template Message API”) provided by the communication provider. The communication provider's platform receives 206 the request to send the test template message from the Send Test Template Message API and verifies that the MSISDN of the intended recipient specified in the request is one of a valid tester or a valid Template Tester. If the MSISDN is a valid tester, the communication provider's platform retrieves a definition of the message template based on the unique template ID, the sender ID, and values of custom variables. The communication provider's platform expands 207 the message template to create the test template message into an underlying rich message for a channel and sends it to the intended recipient via a channel platform using the “Send Channel Message API” of the channel platform. FIG. 10A illustrates screenshot of a graphical user interface displaying “Test message(s) sent successfully!”. FIG. 10B illustrates screenshot of a graphical user interface displaying status of the test message sent to the selected test device. The Send Message API on the communication provider's platform is likely to be similar to the Send Channel Message API on the channel platform in terms of the functionality, whereas the syntax of these two APIs may be the identical, similar or different. The difference between these two APIs is that the Send Message API is supported on the communication provider's platform whereas the Send Channel Message API is supported on the channel platform.

The intended recipient i.e., valid tester receives the Test Template message. The CPaaS provider's platform receives 208 a confirmation from the intended recipient that the test template message is as per expectation. Furthermore, the business user or developer is able to confirm that the message is as per their expectation. In an embodiment, the business user or developer can update the message template or delete and create a new message template to make desired changes in the template and repeats the process of testing the template. The CPaaS provider's platform also includes a feature to “Submit Template for Approval”. After the business user or developer is satisfied with the definition of the message template, they can select the “Submit Template for Approval” option for the message template. Once the communication provider approves the message template, its status can be pushed back to CPaaS provider's platform or fetched by CPaaS provider's platform.

The first method ensures that the business users or developers on the CPaaS provider's platform can test a message template by sending it to an MSISDN that has already been added or designated as a Tester, before submitting the template for approval. Furthermore, this method ensures that the Business users or developers on the CPaaS provider's platform cannot send a message template to an MSISDN who is not a tester, prior to approval of the Template. This approach is important to ensure that the rules related to Template Messages cannot be circumvented.

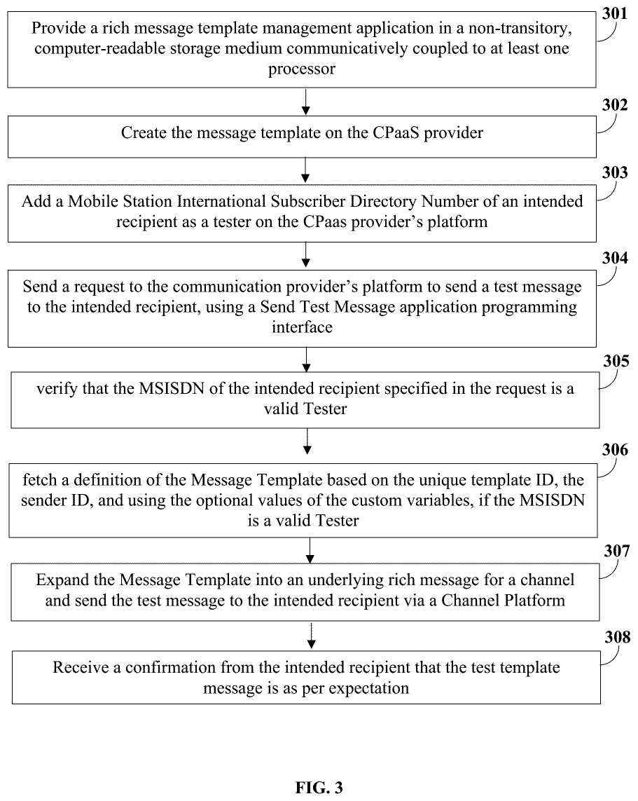

FIG. 3 illustrates a flowchart of a second method for a communication platform as a service (CPaaS) Providers to test message templates from their platform. The method employs 301 a rich message template management application (RMTMA) in a non-transitory, computer-readable storage medium communicatively coupled to at least one processor. The non-transitory computer-readable storage medium is configured to store computer program instructions executable by the at least one processor. The computer program instructions, when executed by the at least one processor, cause at least one processor to manage actions associated with testing message templates. This method relies on the communication provider providing or defining a “Send Test Message” application programming interface (“Send Test Message” API) for sending a message to a Tester, even when they are not in a Conversation. The message being sent may or may not be a template message. The input parameters of the Send Test Message API includes: 1) a Mobile Station International Subscriber Directory Number (MSISDN) of an intended Recipient; and 2) an underlying Message in the form of a JSON object, or in XML, or any other format, similar to the one used in Send Channel Message API.

The CPaaS provider allows a business user or a developer to create 302 a message template on the CPaaS provider's platform. The business user or developer uses the ‘Add Tester’ feature on the CPaaS provider's platform to add 303 an intended recipient's MSISDN as a Tester. The CPaaS provider's platform sends the request to add a Tester to the communication provider's platform. Depending on the specific channel, there is a process to make the MSISDN as a Tester. For example, for rich communication services (RCS) channel, the intended recipient's MSISDN will receive a Tester Invite, which the user must accept in order to become a Tester. In another example, the CPaaS provider's platform and the communication provider's platform implement a Test Template Tester feature to add an intended recipient's MSISDN as a Template Tester, distinct from being a Tester who can receive a message from an RCS Sender that has not been verified and launched. In another example, in order to become a tester on WhatsApp, the user may need to send a message to a sandbox number to emulate communication with the sender ID of the business. In another example, users can register to become testers in various ways depending on the channel platform they choose.

The CPaaS provider's platform includes a feature that allows the business users or developers to Test Templates by selecting the created message template and specifying the MSISDN of the intended recipient, and optionally the value(s) of the custom variables, if any. In an embodiment, the CPaaS provider's platform may or may not verify that the specified or selected MSISDN is a valid Tester for that channel and the sender ID of the Business. The CPaaS provider's platform sends 304 a request to the communication provider's platform to send a test message to the intended recipient, using a “Send Test Message” application programming interface (“Send Test Message” API). The CPaaS provider's platform verifies 305 that the MSISDN of the intended recipient specified in the request is a valid Tester. If the MSISDN is a valid Tester, the CPaaS provider's platform fetches a definition of the message template based on the unique template ID, the sender ID, and using the optional values of the custom variables. The CPaaS provider's platform expands 307 the message template into an underlying rich message for a channel and sends the test message to the intended recipient via a channel platform using the “Send Channel Message API” of the channel platform. The Send Test Message API on the communication provider's platform is likely to be similar to the Send Channel Message API on the channel platform in terms of the functionality, whereas the syntax of these two APIs may be the identical, similar or different. The difference between these two APIs is that the Send Test Message API is supported on the communication provider's platform whereas the Send Channel Message API is supported on the channel platform.

The intended recipient i.e., valid tester receives the Test message and the business user or developer is able to confirm 308 that the test message is as per expectation. In an embodiment, the business user or developer can update the message template or delete and create a new message template to make desired changes in the template and repeats the process of testing the template. The CPaaS provider's platform also includes a feature to “Submit Template for Approval”. After the business user or developer is satisfied with the definition of the message template, they can select the “Submit Template for Approval” option for the message template. Once the communication provider approves the message template, its status can be pushed back to CPaaS provider's platform or fetched by CPaaS provider's platform. The second method ensures that the business users or developers on the CPaaS provider's platform can test a template by sending it to an MSISDN that has already been added as a Tester, before submitting the template for approval. Furthermore, this method ensures that the business users or developers on the CPaaS provider's platform cannot send a message template to an MSISDN who is not a tester, prior to approval of the Template. This approach is important to ensure that the rules related to Template Messages cannot be circumvented.

The method 2 differs from method 1 in the following ways: 1) The communication provider has less control over the range of Messages that a CPaaS provider's platform can send to testers, as there is no option to create a message template on the communication provider's platform; and 2) practically, there is little difference as the CPaaS Provider can use the Template Management API to create any message template and send the message to testers using method 1. To summarize, both method 1 and method 2, achieve the intended goal of allowing the business users to test templates without the ability to circumvent message template rules for non-testers.

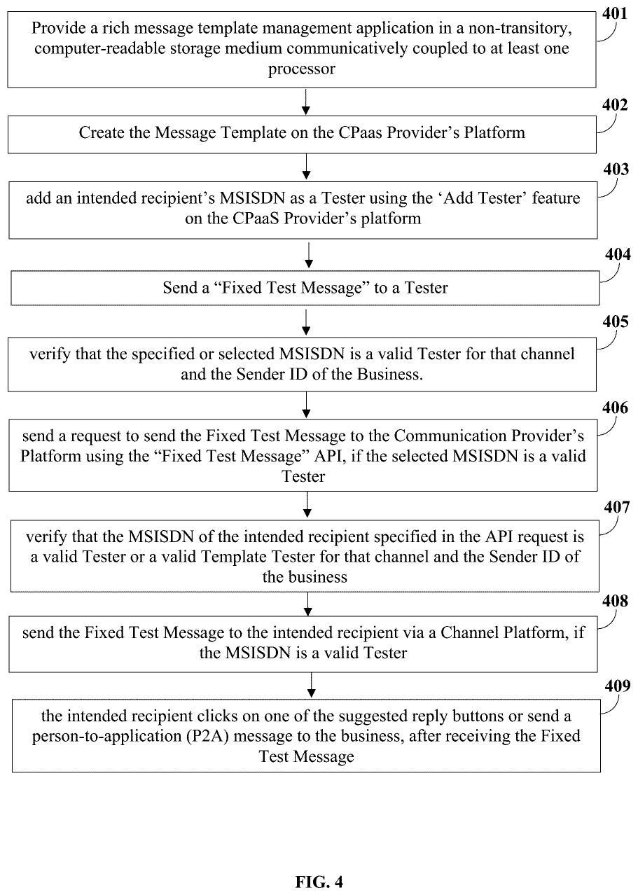

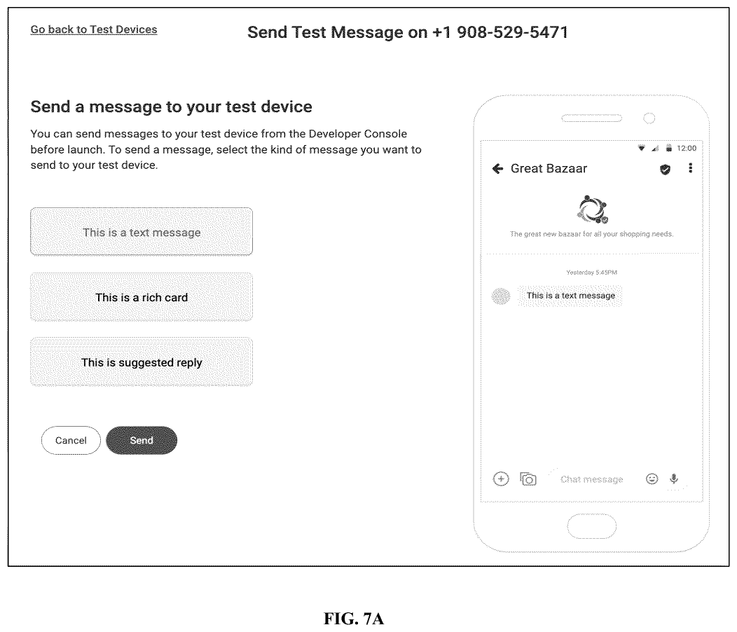

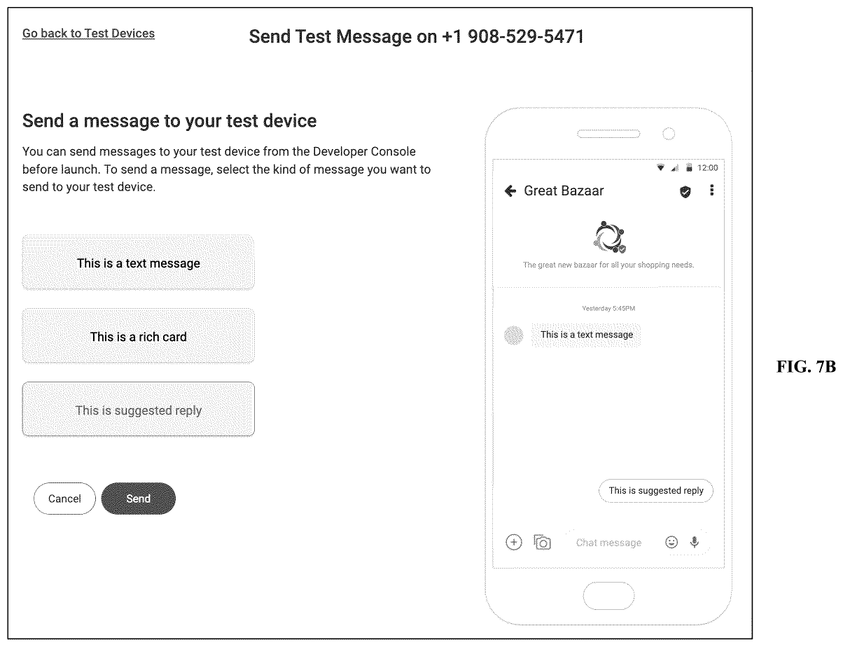

FIG. 4 illustrates a flowchart of a third method for a communication platform as a service (CPaaS) Providers to test message templates from their platform. The method employs 401 a rich message template management application (RMTMA) in a non-transitory, computer-readable storage medium communicatively coupled to at least one processor. The non-transitory computer-readable storage medium is configured to store computer program instructions executable by the at least one processor. The computer program instructions, when executed by the at least one processor, cause at least one processor to manage actions associated with testing message templates. This method relies on the communication provider providing a “Send Fixed Test Message” application programming interface (“Send Fixed Test Message” API) for sending one of a set of Fixed Test Messages to a Tester, even when they are not in a Conversation. The input parameters of the Send Fixed Test Message API includes: 1) a Mobile Station International Subscriber Directory Number (MSISDN) of an intended Recipient; and 2) a Fixed Message identifier (ID). Examples of Fixed Messages are Text Message with Suggestions, Rich Card with Suggestions, and Rich Card Carousel, as illustrated in FIGS. 7A-7B. In another example, one or more of the Fixed Test Messages include a suggested reply button such as “Start Conversation” or “Start Testing”, or “Enable Template Testing”.

The CPaaS provider allows a business user or a developer to create 402 a message template on the CPaaS provider's platform. The business user or developer uses the ‘Add Tester’ feature on the CPaaS provider's platform to add 403 an intended recipient's MSISDN as a Tester. The CPaaS provider's platform sends the request to add a Tester to the communication provider's platform. Depending on the specific channel, there is a process to make the MSISDN as a Tester. For example, for rich communication services (RCS) channel, the intended recipient's MSISDN will receive a Tester Invite, which the user must accept in order to become a Tester. In another example, the CPaaS provider's platform and the communication provider's platform implement a Test Template Tester feature to add an intended recipient's MSISDN as a Template Tester, distinct from being a Tester who can receive a message from an RCS Sender that has not been verified and launched. In another example, in order to become a tester on WhatsApp, the user may need to send a message to a sandbox number to emulate communication with the sender ID of the business. In another example, users can register to become testers in various ways depending on the channel platform they choose.

The CPaaS provider's platform includes a feature that allows the business users or developers to send 404 a “Fixed Test Message” to a Tester. The business user or developer selects one of the Fixed Test Messages, selects or specifies the MSISDN of a Tester and send the Fixed Test Message. The CPaaS provider's platform verifies 405 that the specified or selected MSISDN is a valid Tester for that channel and the sender ID of the Business. If it is a valid Tester, the CPaaS provider's platform sends 406 a request to send the Fixed Test Message to the communication provider's platform using the “Fixed Test Message” API. The communication provider's platform verifies 407 that the MSISDN of the intended recipient specified in the API request is a valid Tester or a valid Template Tester for that channel and the sender ID of the business. If the MSISDN is a valid Tester, the communication provider's platform sends 408 the Fixed Test Message to the intended recipient via a channel platform using the underlying API of the channel platform.

The intended recipient i.e., valid tester receives the Fixed Test Message. After receiving the Fixed Test Message, the intended recipient clicks 409 on one of the suggested reply buttons or send a person-to-application (P2A) message to the business. The P2A response, such as user clicking on a suggested reply button or P2A message from the user, starts the “Conversation Window”, allowing any message to be sent to the Tester, without the need of a pre-approved Template.

The CPaaS provider's platform also includes a feature to allow the business users or developers to Test Template by selecting the Template created and specifying or selecting the intended recipient's MSISDN, and optionally the value(s) of the custom variables, if any. The CPaaS provider's platform verifies that the specified or selected intended recipient's MSISDN is currently in a “Conversation Window”. If not, the business user or developer is prompted to send the Fixed Test Message to the intended recipient and/or to ask intended recipient to respond to the message already sent. If the intended recipient's MSIDN is in Conversation Window, the CPaaS provider's platform fetches the definition of the message template based on the unique template ID, sender ID, and the optional values of the custom variables. The CPaaS provider's platform expands the template into the underlying rich message for the channel and sends it to the channel platform using the underlying Send Channel Message API of the channel platform. Since the intended recipient's MSISDN is in a conversation window, the message will be sent to the intended recipient's MSISDN by the communication provider's platform.

The intended recipient i.e., valid tester receives the Test Template message and the business user or developer is able to confirm that the test message is as per expectation. In an embodiment, the business user or developer can update the message template or delete and create a new message template to make desired changes in the template and repeats the process of testing the template. The CPaaS provider's platform also includes a feature to “Submit Template for Approval”. After the business user or developer is satisfied with the definition of the message template, they can select the “Submit Template for Approval” option for the message template. Once the communication provider approves the message template, its status can be pushed back to CPaaS provider's platform or fetched by CPaaS provider's platform.

The third method ensures that the business users or developers on the CPaaS provider's platform can test a template by sending it to an MSISDN that has already been added as a Tester, before submitting the template for approval. Furthermore, this method ensures that the business users or developers on the CPaaS provider's platform cannot send a message template to an MSISDN who is not a tester, prior to approval of the Template. This approach is important to ensure that the rules related to Template Messages cannot be circumvented.

The third method differs from both first method and second method in the following ways: The third method relies on communication provider allowing one or more of a set of Fixed Test Messages to be sent to Testers, followed by a P2A Response from the tester to initiate a Conversation Window. The third method can also be used with non-testers who have received some other message in the past and send a P2A Response to initiate a Conversation Window. Furthermore, the third method can be used in place of, or in conjunction with the first method and the second method.

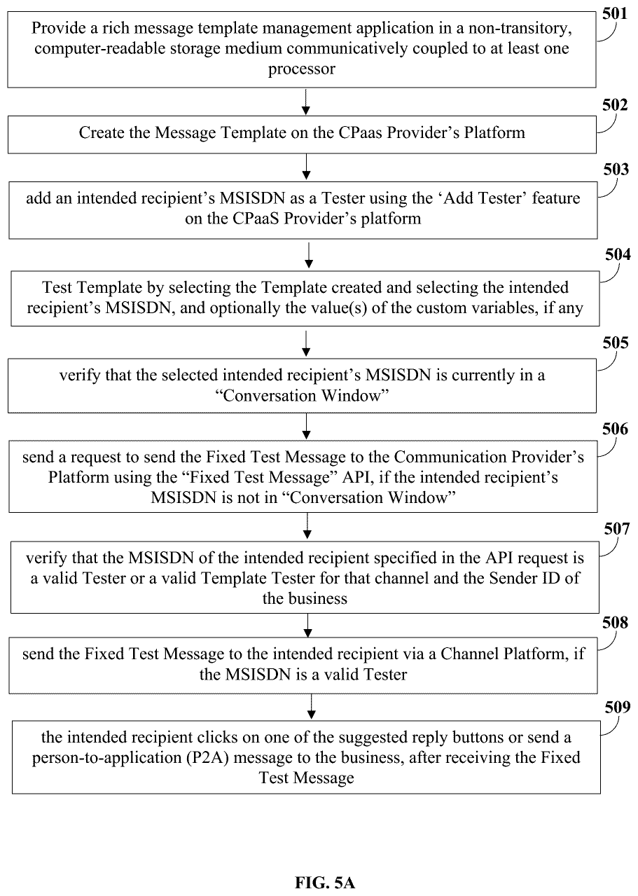

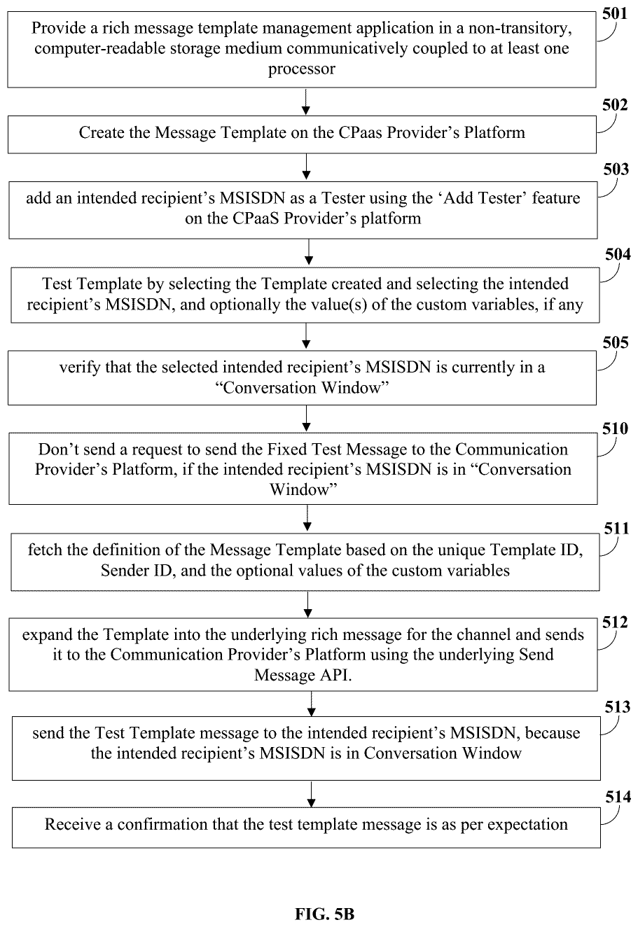

FIGS. 5A-5B illustrates a flowchart of a fourth method for a communication platform as a service (CPaaS) Providers to test message templates from their platform is disclosed. The method employs 501 a rich message template management application (RMTMA) in a non-transitory, computer-readable storage medium communicatively coupled to at least one processor. The non-transitory computer-readable storage medium is configured to store computer program instructions executable by the at least one processor. The computer program instructions, when executed by the at least one processor, cause at least one processor to manage actions associated with testing message templates. This method relies on the communication provider providing a “Send Fixed Test Message” application programming interface (“Send Fixed Test Message” API) for sending one of a set of Fixed Test Messages to a Tester, even when they are not in a Conversation. The input parameters of the Send Fixed Test Message API includes: 1) a Mobile Station International Subscriber Directory Number (MSISDN) of an intended Recipient; and 2) a Fixed Message identifier (ID). Examples of Fixed Messages are Text Message with Suggestions, Rich Card with Suggestions, and Rich Card Carousel, as illustrated in FIGS. 2A-2B. In another example, one or more of the Fixed Test Messages include a suggested reply button such as “Start Conversation” or “Start Testing”, or “Enable Template Testing”.

The CPaaS provider allows a business user or a developer to create 502 a message template on the CPaaS provider's platform. The business user or developer uses the ‘Add Tester’ feature on the CPaaS provider's platform to add 503 an intended recipient's MSISDN as a Tester. The CPaaS provider's platform sends the request to add a Tester to the communication provider's platform. Depending on the specific channel, there is a process to make the MSISDN as a Tester. For example, for rich communication services (RCS) channel, the intended recipient's MSISDN will receive a Tester Invite, which the user must accept in order to become a Tester. In another example, the CPaaS provider's platform and the communication provider's platform implement a Test Template Tester feature to add an intended recipient's MSISDN as a Template Tester, distinct from being a Tester who can receive a message from an RCS Sender that has not been verified and launched. In another example, in order to become a tester on WhatsApp, the user may need to send a message to a sandbox number to emulate communication with the sender ID of the business. In another example, users can register to become testers in various ways depending on the channel platform they choose.

The CPaaS provider's platform also includes a feature to allow the business users or developers to Test 504 Template by selecting the Template created and specifying or selecting the intended recipient's MSISDN, and optionally the value(s) of the custom variables, if any. The CPaaS provider's platform verifies 505 that the specified or selected intended recipient's MSISDN is currently in a “Conversation Window”. If the intended recipient's MSISDN is not in “Conversation Window”, the CPaaS provider's platform sends 506 a request to send the Fixed Test Message to the communication provider's platform using the “Fixed Test Message” API. The communication provider's platform verifies 507 that the MSISDN of the intended recipient specified in the API request is a valid Tester or a valid Template Tester for that channel and the sender ID of the business. If the MSISDN is a valid Tester, the communication provider's platform sends 508 the Fixed Test Message to the intended recipient via a channel platform using the underlying API of the channel platform.

The intended recipient i.e., valid tester receives the Fixed Test Message. After receiving the Fixed Test Message, the intended recipient clicks 509 on one of the suggested reply buttons or send a person-to-application (P2A) message to the business. The P2A response, such as user clicking on a suggested reply button or P2A message from the user, starts the “Conversation Window”, allowing any message to be sent to the Tester. If the intended recipient's MSISDN is in “Conversation Window”, there is no need for the CPaaS provider's platform to send 510 a request to send the Fixed Test Message. The CPaaS Provider's platform fetches 511 the definition of the message template based on the unique template ID, sender ID, and the optional values of the custom variables. The CPaaS Provider's platform expands 512 the Template into the underlying rich message for the channel and sends it to the communication provider's platform using the underlying Send Message API. Since the intended recipient's MSISDN is in Conversation Window, the Test Template message will be sent 513 to the intended recipient's MSISDN by the communication provider's platform.

The intended recipient i.e., valid tester receives the Test Template message and the business user or developer is able to confirm 514 that the test message is as per expectation. In an embodiment, the business user or developer can update the message template or delete and create a new message template to make desired changes in the template and repeats the process of testing the template. The CPaaS provider's platform also includes a feature to “Submit Template for Approval”. After the business user or developer is satisfied with the definition of the message template, they can select the “Submit Template for Approval” option for the message template. Once the communication provider approves the message template, its status can be pushed back to CPaaS provider's platform or fetched by CPaaS provider's platform.

The fourth method is an improvement over the third method in the following ways: In the third method the business user or developer does not have to explicitly request to send the Fixed Test Message. Instead, the CPaaS provider's platform sends the Fixed Test Message to the intended recipient i.e., Tester, is the recipient is not already in Conversation Window.

A fifth method is a variation of the third method, and can be implemented by a CPaaS Provider without requiring any support from the communication provider to provide the Send Fixed Test Message API. In the fifth method, the CPaaS provider's platform creates one or more Special message templates on the communication provider's platform and submits them for Approval. Once these Special message templates are approved, the CPaaS provider's platform sends one of the Approved Special Template Messages to the user instead of calling the Send Fixed Test Message API, and then have the user send a P2A Response to initiate a Conversation Window. Once a Conversation Window is initiated, the CPaaS provider's platform can expand the Template and send the message using the underlying channel API.

A sixth method is another variation of the third method that can be implemented by a CPaaS Provider by generating a P2A Deeplink URL or QR Code and sending it to the user. The sixth method can be implemented by the CPaaS Provider without any support from the communication provider. The P2A Deeplink URL can be sent over SMS or from a sender ID belonging to the CPaaS Provider, or the tester user can scan a QR Code. User clicks on the Deeplink URL to send a P2A message to the sender ID of the business and initiate a Conversation Window. Once a Conversation Window is initiated, the CPaaS provider's platform can expand the template and send the message using the underlying channel API.

A seventh method is variation of the sixth method where the communication provider creates and publishes the Deeplink for every sender ID created by the CPaaS Providers.

An eight method is a variation of the sixth method, where a customized Deeplink URL and/or QR Code is created for every Template that needs to be tested. The Deeplink URL sent to the user includes a Keyword that is populated in the chat window with the sender ID of the Business. This Keyword identifies the Template being tested. After user clicks on the customized Deeplink, and sends the keyword to the sender ID of the Business, an application on the CPaaS provider's platform parses the keyword, identifies the Template Message associated with the keyword and sends the Template, by expanding it with the value of the custom variables, using the underlying Send Message API on the communication provider's platform.

A ninth method is a variation of the first method, where a business user or developer can send messages for non-approved message templates to any user, provided the number of such messages does not exceed a specified limit or follows some other specified rules. As used herein, the term “non-approved message template” refers to a message template that is not approved or is pending for approval. Also, as used herein, the term “user” refers to one of a verified or non-verified individual, a device, a number, a phone number associated with a device, etc., who can receive, review, and evaluate message templates. The specified limit can be one of a common system wide limit applicable to all message templates, or a limit defined for each brand and/or sender, with a default set to the system wide limit. When the business user or developer on the CPaaS provider's platform wants to send a Test Template Message to the user, the CPaaS Provider's platform sends a request to the communication provider's platform to send the Test Template Message to the user using the existing Send Template Message API on the communication provider's platform. Upon receiving the request to send the Test Template Message, the communication provider's platform determines whether the Test Template Message is approved. If the Test Template Message is not approved, the communication provider's platform checks a counter tracking the number of messages already sent for the Test Template Message. If the counter has not exceeded the specified limit, the communication provider's platform sends the Test Template Message after expanding it and then increments the counter.

The ninth method allows the business user or developers using the CPaaS Provider's platform to send a specified number of messages to test a Test Template Message, subject to the specified limits and/or rules. The ninth method allows the use of the existing “Send Template Message API”, but with specified criteria to limit the number of messages sent for non-approved message templates. Examples of how to limit which messages are permitted are: a) A maximum number of messages allowed per template during its lifetime before it is approved; this can be a system wide limit or brand or agent level limit; b) A maximum number of messages allowed per template per day before it is approved; this can be a system wide limit or brand or agent level limit; c) A maximum amount of time that can pass after the creation of the template during which template can be sent without approval; and d) Allow non approved templates to be sent only to testers. A combination of one or more of these rules can be used to limit which messages are permitted.

### Existing API's Relevant to the Invention

Example of an RCS API for sending native messages (Existing)

An example of an RCS API is the GSMA “RCS MaaP Chatbot API Specifications” (Version 1.0 27 Nov. 2017), also commonly referred to as FNW.11 https://www.gsma.com/futurenetworks/wp-content/uploads/2017/11/FNW.11_v1.0.pdf

RCS Universal Profile 2.x supports various types of messages that can be sent to users, including text message, file, audio message, geolocation push, rich card, and suggested chip list. This API allows the communication provider's platform to send messages and is Typing indications to users. It also supports methods to check status of a message, receive delivery report (indicating that a message has been delivered to a user's device) and read receipt (indicating that a message has been displayed on the user's device).

Additionally, this API also supports methods to check the capability of a user.

This is an example of a “Send Channel Message API” on a channel platform as well as an example of “Send Message API” on communication provider's platform.

### API Method 1: Send Message

```
Request format:
https://{serverRoot}/bot/{apiVersion}/{botId}/messages
Example 1: Send Text Message
{
  “RCSMessage”:{
    “textMessage”:“hello world”
  },
  “messageContact”: {
    “userContact”: “+914253136789”
  }
}
Response Format:
{
  “RCSMessage”: {
      “msgId”: “6cd095cd-62f6-4338-bba2-4b14b98b0537”,
      “status”: “pending”
  }
}
```

### Additional Examples

```
Send File Message
{
    “RCSMessage”: {
  “fileMessage”: {
        “fileUrl” : “ https://storage.dotgo.com/sample-images/cute-dog.jpg”
        }
  },
  “messageContact”: {
        “userContact”: “+14251234567”
  }
}
Send Rich Card with Suggested chiplist
{
“RCSMessage”: {
      “trafficType”: “advertisement”,
      “richcardMessage”: {
        “message”: {
          “generalPurposeCard”: {
            “layout”: {
              “cardOrientation”: “HORIZONTAL”,
              “imageAlignment”: “LEFT”
            },
            “content”: {
              “media”: {
                “mediaUrl”: “ https://storage.googleapis.com/kitchen-sink-sample-images/cute-
dog.jpg”,
                “mediaContentType”: “image/jpg ”,
                “mediaFileSize”: 2718288,
                “thumbnailUrl”: “ https://storage.dotgo.com/sample-images/cute-dog.jpg ”,
                “thumbnailContentType”: “image/jpg ”,
                “thumbnailFileSize”: 314159,
                “height”: “MEDIUM_HEIGHT”,
                “contentDescription”: “Textual description of media content, e.g. for use with
screen readers.”
              },
              “title”: “This is a single rich card.”,
              “description”: “This is the description of the rich card. It's the first field that will be
truncated if it exceeds the maximum width or height of a card.”
            }
          }
        }
      },
      “suggestedChipList”: {
        “suggestions”: [
          {
            “reply”: {
              “displayText”: “Yes”,
              “postback”: {
                “data”: “set_by_chatbot_reply_yes”
              }
            }
          },
          {
            “reply”: {
              “displayText”: “No”,
              “postback”: {
                “data”: “set_by_chatbot_reply_no”
              }
            }
          },
          {
            “action”: {
              “urlAction”: {
                “openUrl”: {
                  “url”: “https://www.dotgo.com/”
                }
              },
              “displayText”: “Open Dotgo website”,
              “postback”: {
                “data”: “set_by_chatbot_open_url”
              }
            }
          }
        ]
      }
  },
  “messageContact”: {
      “userContact”: “+14251234567”
  }
}
```

### API Method 2: Query Message Status

```
Request format:
https://{serverRoot}/bot/{apiVersion}/{botId}/messages//{msgId}/status
Example:
Request:
  No request body
Response: 200OK
{
  “RCSMessage”: {
    “msgId”: “ddc24c2-cff5-48ac-baaa-4f286bc28061”,
    “status”: “sent”,
    “timestamp”: “2023-08-04T11:06:26”
  }
}
```

### API Method 3: Revoke a Message

A message that has been sent but not yet delivered to the user can be revoked using the Revoke method.

```
Request format:
https://{serverRoot}/bot/{apiVersion}/{botId}/messages//{msgId}/status
Request:
{
  “RCSMessage”: {
    “status”: “cancelled”
  }
}
Response:204 No Content
        No response body
          API Method 4: Check RCS Capability of user
Request format:
https://{serverRoot}/bot/{apiVersion}/{botId}/contactCapabilities?
userContact=+914253136788
Example:
GET https://{serverRoot}/bot/{apiVersion}/{botId}/contactCapabilities?
userContact=+914253136788
Response Format:
{
    “capabilities”: [
      “chatBotCommunication”,
      “chat”,
      “fileTransfer”
    }
}
```

Example of a Send Template Message API for Sending RCS Template Message. This is an example of “Send Template Message API” on communication provider's platform.

### Send RCS Template Message APIs

Can use a different endpoint or same as the one used for sending native RCS messages.
In this example, we are showing the use of the same API endpoint and access mechanism.
The difference is in the body of the request sent on the API.

### Example of Sending a Template Message

```
{
  “RCSMessage”: {
    “templateMessage”: {
      “templateCode”:“template_123”,
      “customParams”:“{\“name:\”:\“John\”}”
    }
  },
  “messageContact”: {
    “userContact”: “+14251234567”
  }
}
```

Example of a Template Management API for RCS message templates

RCS Template. Management API

The RCS Template is a predefined set of RBM UI elements for e.g., a Rich Card with suggestions which can be used as a base for formulating messages in your campaign to the target audience.

Once a bot is created, the developer can create multiple templates against the bot and use them for running campaigns. You can add images, videos, and suggested actions for your template.

Different types of templates may be supported. Some examples of template types include:
Text message template
Rich Card Template
Rich Card Carousel Template
Media message template
Text and Media message template
PDF Template
Text and PDF Template

A communication provider may offer UI tools on its platform to create, list, view, edit, and delete templates. Additionally, some communication providers may offer RCS Template Management API to enable the CPaaS Provider's to manage template using an API instead of using a UI tools on the platform.

Some examples of the methods supported by an RCS Template Management API create, update, delete, view and view status.

### Create:

POST https://{serverRoot}/manage/{apiVersion}/rcsTemplate

### Get Template Status:

GET https://{serverRoot}/manage/{apiVersion}/rcsTemplateStatus/{templateId}

### Update:

PUT https://{serverRoot}/manage/{apiVersion}/rcsTemplate

### Delete:

DELETE https://{serverRoot}/manage/{apiVersion}/rcsTemplate/{templateId}

### Get Template Details:

GET https://{serverRoot}/manage/{apiVersion}/rcsTemplate/{templateId}

### New APIs Proposed for the Invention

Example of an API to send Test RCS Template Message (Solution 1). This is an example of “Send Test Template Message API”.

### Send Test RCS Template Message APIs

Can use a different endpoint or same as the one used for sending RCS Template messages.
In this example, we are showing the use of the same API endpoint and access mechanism as that for sending RCS Template Message.
The difference is in the body of the request sent on the API.
   Example of Message Body to send a Request to Test RCS Template Message (Style 1)

```
{
  “RCSMessage”: {
      “testTemplateMessage”: {
        “templateCode”:“template_123”,
        “customParams”:“{\“name:\”:\“TestTemplate1\”}”
      }
  },
  “messageContact”: {
    “userContact”: “+14251234567”
  }
}
```

### Example of Message Body to Send a Request to Test RCS Template Message (Style 2)

```
{
  “TestRCSMessage”: {
    “templateMessage”: {
      “templateCode”:“template_123”,
      “customParams”:“{\“name:\”:\“TestTemplate1\”}”
    }
  },
  “messageContact”: {
    “userContact”: “+14251234567”
  }
}
```

### Example of an API to Send Test RCS Messages (Solution 2)

This is an example of “Send Test Message API”.

### Send Test RCS Message APIs

Can use a different endpoint or same as the one used for sending native RCS messages.
In this example, we are showing the use of the same API endpoint and access mechanism as that for sending RCS Messages.
The difference is in the body of the request sent on the API.
Instead of using RCSMessage, use TestRCSMessage.
The rest of the format in the request is same as that for sending an RCS Message.
The examples below show the format for an RCS Text Message and an RCS File Message.
The Send Test RCS Message API can be used to send other RCS messages as well.

### Example 1. Test Text Message

```
{
  “TestRCSMessage”:{
    “textMessage”:“hello world”
  },
  “messageContact”:{
    “userContact”:“+914253136789”
  }
}
```

### Example 3: Test File Message

```
{
    “TestRCSMessage”: {
  “fileMessage”: {
      “fileUrl” : “ https://storage.dotgo.com/sample-images/
      cute-dog.jpg”
      }
  },
  “messageContact”: {
      “userContact”: “+14251234567”
  }
}
```

Example of an API for sending one of a Set of Fixed Test Messages (Solution 3)

### Fixed Test RCS Message API

Can use a different endpoint or same as the one used for sending native RCS messages.
In this example, we are showing the use of the same API endpoint and access mechanism as that for sending RCS Messages.
The difference is in the body of the request sent on the API.
Instead of using RCSMessage, use TestFixedRCSMessage.
The examples below show the format for an RCS Text Message and an RCS File Message.
   Example: Send Fixed RCS Message (Text Message with Suggested Chiplist)

```
{
  “TestRCSFixedMessage”: {
    “fixedRCSMessage”: {
      “fixedRCSMessageId”:“FixedMsgText”
    }
  },
  “messageContact”: {
    “userContact”: “+14251234567”
  }
}
```

The Fixed Text Message would include a Suggested Reply button, such as “Start Testing” as part of Suggested Chiplist to the Text message.

### Example: Send Fixed RCS Message (Rich Card Message)

```
{
  “TestRCSFixedMessage”: {
    “fixedRCSMessage”: {
      “fixedRCSMessageId”:“FixedMsgRichCard”
    }
  },
  “messageContact”: {
    “userContact”: “+14251234567”
  }
}
```

The Fixed Rich Card Message would include a Suggested Reply button, such as “Start Testing” as part of Menu options associated with the Rich Card.

Solution 4: Solution 4 is implemented without the need for any extra features or API calls to be supported by the communication provider.
1) CPaaS provider's platform creates a Special message template “SpecialFixed1” using the Template Management API and submits for approval.
2) The Special message template “SpecialFixed1” is approved.
3) Developer defines a new Template, for example “BrandTemplate1” for the Business on the CPaaS provider's platform.
4) Developer makes request to Test the Template “BrandTemplate1” on the CPaaS provider's platform.
5) CPaaS provider's platform first sends the approved Template “SpeacialFixed1” to the user.
6) User clicks on the suggested action button “Start Testing” or sends a P2A Message to initiate a conversation window.
7) Once a conversation window is initiated, the CPaaS provider's platform expands the Template “BrandTemplate1” and send the message using the underlying Send RCS Message API.

Solution 5: Solution 5 is another variation of Solution 3 that can be implemented by a CPaaS Provider by generating a P2A Deeplink URL and sending it to the user.
1) Developer defines a new Template, for example “BrandTemplate1” for the Business on the CPaaS provider's platform.
2) Developer makes request to Test the Template “BrandTemplate1” on the CPaaS provider's platform.
3) CPaaS provider's platform generates a P2A Deeplink URL for the RBM Agent of the Brand and sends it as an SMS or as an RCS message from a sender ID belonging to the CPaaS provider.
4) User clicks on the deeplink URL and sends the P2A Message “GetTest” to initiate a Conversation Window.
5) Once a Conversation Window is initiated, the CPaaS provider's platform expands the Template “BrandTemplate1” and send the message using the underlying Send RCS Message API.

Solution 6: Solution 6 is a variation of Solution 5, where a customized deeplink URL is created for every Template that needs to be tested.
1) Developer defines a new template, for example “BrandTemplate1” for the Business on the CPaaS provider's platform.
2) Developer makes request to Test the Template “BrandTemplate1” on the CPaaS provider's platform.
3) CPaaS provider's platform generates a customer P2A Deeplink URL for the RBM Agent of the Brand and for the Template “BrandTemplate1” and sends it as an SMS or as an RCS message from a sender ID belonging to the CPaaS provider.
4) User clicks on the customized deeplink URL and sends the P2A Message included in the body of the URL to initiate a Conversation Window.
5) The CPaaS provider's platform receives the P2A Message with a value (for example BrandTemplate1) that is mapped to identify the Template being tested.
6) Once a Conversation Window is initiated, the CPaaS provider's platform expands the Template “BrandTemplate1” and send the message using the underlying Send RCS Message API.

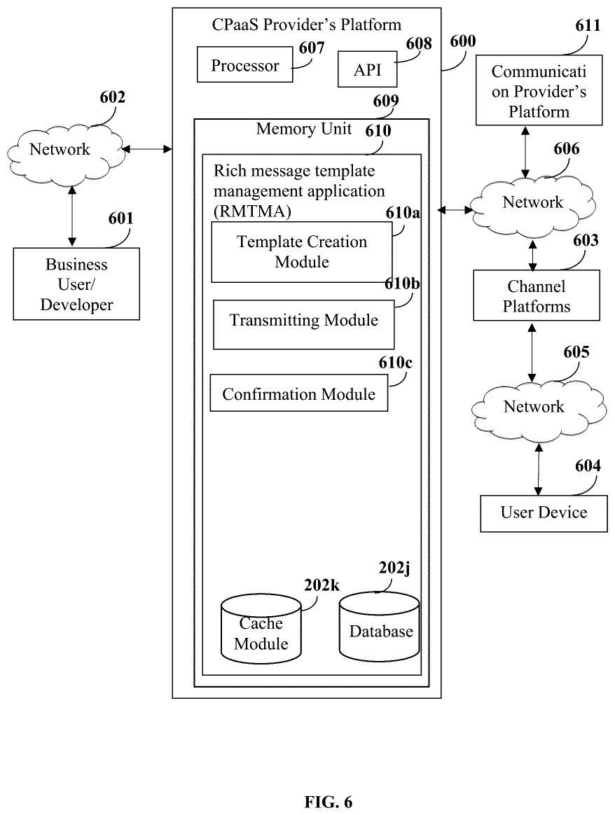

FIG. 6 exemplarily illustrates an architectural block diagram of an exemplary implementation of a system i.e., CPaaS provider's platform 600 for testing a message template is provided. The CPaaS provider's platform 600 disclosed herein is a computer system programmable using high-level computer programming languages. The CPaaS provider's platform 600 is accessible to a business user or a developer 601 via a network 602 through a broad spectrum of technologies and devices such as personal computers with access to the internet, laptops, mobile computing devices, smart phones, tablet computing devices, servers, workstations, a portable electronic device, a network-enabled computing device, an interactive network-enabled communication device, any other suitable computing equipment, combinations of multiple pieces of computing equipment, etc. Furthermore, the system communicates with multiple messaging platforms that host rich messaging channels, via a network. The channel platforms 603 comprise, for example, Google Business Messages (GBM), WhatsApp®, Rich Communication Services (RCS), iMessage®, Viber®, Facebook® Messenger, etc. Furthermore, the channel platforms 603 are accessible to a user device 604 of an intended recipient via a network 605. The user device 604 is an electronic device, for example, one or more of a personal computer, a tablet computing device, a mobile computer, a mobile phone, a smartphone, a portable computing device, a laptop, a personal digital assistant, a wearable computing device such as smart glasses, a smart watch, etc., a touch centric device, a workstation, a client device, a portable electronic device, a network-enabled computing device, an interactive network-enabled communication device, an image capture device, any other suitable computing equipment, combinations of multiple pieces of computing equipment, etc.

The user device 604 comprises a messaging client (not show) implemented, for example, on the Android® platform of Google Inc., the iOS platform of Apple Inc., the Windows® platform of Microsoft Corporation, or other platforms. The messaging client is configured to receive messages, for example, rich messages, short message service (SMS) messages, etc., via the network 606. The messaging client is, for example, the WhatsApp® instant messaging application, the iMessage® instant messaging application, the Viber® messaging application, Facebook® Messenger, etc. The networks 602, 605, and 606 that connect the CPaaS provider's platform 600 to the business user 601, the channel platforms 603, communication provider's platform 611, and the user device 604, respectively, are each, for example, one of the internet, satellite internet, a wireless network, a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

The CPaaS provider's platform 600 disclosed herein interfaces with the devices of the business user or developer 601 and the channel platforms 603, and in turn, with the user device 604, and in an embodiment, with one or more database systems (not shown) and servers (not shown) to implement the message template testing service, and therefore more than one specifically programmed computing system is used for implementing the message template testing service. As exemplarily illustrated in FIG. 6, the CPaaS provider's platform 600 comprises at least one processor 607, an application programming interface (API) 608 configured for rich messages, and a non-transitory, computer readable storage medium, for example, a memory unit 609. As used herein, “non-transitory, computer-readable storage medium” refers to all computer readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The CPaaS provider's platform 600 further comprises the rich message template management application (RMTMA) 610 configured to define computer program instructions executable by at least one processor 607. The non-transitory, computer readable storage medium, herein exemplarily referred to as the memory unit 609, is configured to store the computer program instructions defined by the RMTMA 610. In an embodiment, the memory unit 609 stores the modules 610a, 610b, and 610c, of the RMTMA 610 as exemplarily illustrated in FIG. 6.

The processor 607 is operably and communicatively coupled to the memory unit 609 for executing the computer program instructions defined by the modules, for example, 610a, 610b, and 610c, of the rich message template management application (RMTMA) 610. The memory unit 609 is a storage unit used for recording, storing, and reproducing data, program instructions, and applications. In an embodiment, the memory unit 609 comprises a random-access memory (RAM) or another type of dynamic storage device that serves as a read and write internal memory and provides short-term or temporary storage for information and instructions executable by the processor 607. The memory unit 609 also stores temporary variables and other intermediate information used during execution of the instructions by the processor 607. In another embodiment, the memory unit 609 further comprises a read-only memory (ROM) or another type of static storage device that stores firmware, static information, and instructions for execution by the processor 607. The modules, for example, 610a, 610b, and 610c, of the RMTMA 610, when loaded into the memory unit 609 and executed by the processor 607, transform the CPaaS provider's platform 600 into a specially-programmed, special purpose computing device configured to implement the functionality disclosed herein. The processor 607 refers to one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, the processor 607 is implemented as a processor set comprising, for example, a programmed microprocessor and a math or graphics co-processor. The RMTMA 610 is not limited to employing the processor 607. In an embodiment, the RMTMA 610 employs a controller or a microcontroller.

The rich message template management application (RMTMA) 610 defines computer program instructions, which when executed by the processor 607, causes the processor 607 to manage actions associated with testing a message template. In the exemplary implementation of the CPaaS provider's platform 600 illustrated in FIG. 6, the RMTMA 610 comprises a template creation module 610a, a transmitting module 610b, a confirmation module 610c. The template creation module 610a is configured to create the message template on a communication provider's platform 611 using one of a user interface (UI) tool, or a “Template Management” application programming interface (“Template Management API”) provided by a communication provider. The input parameters of the Template Management API includes: 1) a Template identifier (ID) which is uniquely identified on the communication provider's platform. In an embodiment, this identifier includes template ID and, optionally, sender ID and/or account ID of a business user or developer 601; 2) a Mobile Station International Subscriber Directory Number (MSISDN) of an intended Recipient i.e., the user device 604; 3) value of custom variables, can be provided optionally, if defined in message template. For example, the values of custom variables can be specified in the form of a name-value pair in a format such as JavaScript Object Notation (JSON) or Extensible Markup Language (XML). For example, the values of custom variables can also be specified as a sequence (or list) of values, where each value maps to a specific custom variable in the message template.

The created message template is tagged with a unique template ID and a sender ID. The business user or developer 601 adds a mobile station international subscriber directory number (MSISDN) of an intended recipient as a tester on the communication provider's platform 611. The CPaaS provider's platform 600 sends the request to add a Tester to the communication provider's platform 611. The CPaaS provider's platform 600 includes a feature that allows the business users or developers 601 to Test Templates by selecting the created message template and specifying the MSISDN of the intended recipient, and optionally the value(s) of the custom variables, if any.

The transmitting module 610b is configured to send a request to the communication provider's platform 611 for sending a test template message to the intended recipient i.e., the user device 604, using a Send Test Template Message application programming interface (not shown) provided by the communication provider's platform. The communication provider's platform 611 receives the request to send the test template message from the Send Test Template Message API and verifies that the intended recipient is a valid tester. If the MSISDN is a valid tester, the communication provider's platform 611 retrieves a definition of the message template based on the unique template ID, the sender ID, and values of custom variables. The communication provider's platform 611 expands the message template to create the test template message into an underlying rich message for a channel and sends it to the intended recipient via a channel platform 603 using the send message application programming interface of the channel platform. The confirmation module 610c is configured to receive a confirmation from the intended recipient 611 that the test template message is as per expectation.

The processor 607 of the system i.e., CPaaS provider's platform 600 disclosed herein retrieves instructions defined by the template creation module 610a, the transmitting module 610b, the confirmation module 610c, etc., from the memory unit 609 for executing their respective functions disclosed above. The modules 610a, 610b, and 610c of the rich message template management application (RMTMA) 610 are disclosed above as software executed by the processor 607. In an embodiment, the modules 610a, 610b, and 610c of the RMTMA 610 are implemented completely in hardware. In another embodiment, the modules 610a, 610b, and 610c of the RMTMA 610 are implemented by logic circuits to carry out their respective functions disclosed above. In another embodiment, the system 600 is also implemented as a combination of hardware and software including the application programming interface (API) 602 and one or more processors, for example, 607, that are used to implement the modules, for example, 610a, 610b, and 610c of the RMTMA 610.

For purposes of illustration, the disclosure herein refers to the modules 610a, 610b, and 610c of the rich message template management application (RMTMA) 610 being run locally on a single computer system 600; however the scope of the RMTMA 610 and the method disclosed herein is not limited to the modules 610a, 610b, and 610c being run locally on a single computer system 600 via an operating system and the processor 607, but extends to running the modules 610a, 610b, and 610c remotely over the network by employing a web browser and a remote server, a mobile phone, or other electronic devices. In an embodiment, one or more portions of the system 600 disclosed herein are distributed across one or more computer systems (not shown) coupled to the network.

The non-transitory, computer-readable storage medium, herein exemplarily referred to as the memory unit 609, stores computer program instructions of the rich message template management application (RMTMA) 610 executable by at least one processor 607 for testing a message template. The computer program instructions when executed by the processor 607 cause the processor 607 to: create the message template on a communication provider's platform, by the CPaaS provider, wherein the created message template is tagged with a unique template ID and a sender ID; add a mobile station international subscriber directory number (MSISDN) of an intended recipient as a tester on the communication provider's platform; send a request to the communication provider's platform for sending a test template message to the intended recipient, using a send test template message application programming interface provided by the communication provider, wherein the communication provider's platform verifies that the intended recipient is a valid tester, wherein if the MSISDN is a valid tester, the communication provider's platform retrieves a definition of the message template based on the unique template ID, the sender ID, and values of custom variables, and wherein the communication provider's platform expands the message template to create the test template message into an underlying rich message for a channel and sends it to the intended recipient via a channel platform using the Send Message application programming interface of the channel platform; and receive a confirmation from the intended recipient that the test template message is as per expectation.

The computer program instructions disclosed above implement the processes of various embodiments disclosed above and perform additional steps that may be required and contemplated to test a message template. When the computer program instructions are executed by the processor(s) 607, the computer program instructions cause the processor(s) 607 to perform the steps of the method to test a message template as disclosed in the descriptions of FIGS. 2-5B. In an embodiment, a single piece of computer program code comprising computer program instructions performs one or more steps of the method disclosed in the descriptions of FIGS. 2-5B. The processor(s) 607 retrieves these computer program instructions and executes them.

A module, or an engine, or a unit, as used herein, refers to any combination of hardware, software, and/or firmware. As an example, a module, or an engine, or a unit includes hardware such as a microcontroller, associated with a non-transitory, computer readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C#, Java®, JavaScript®, Fortran, Ruby, Perl®, Python®, Visual Basic®, hypertext pre-processor (PHP), Microsoft®.NET, Objective-C®, the Swift™ programming language of Apple Inc., etc. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

In an embodiment, the system disclosed herein comprises at least one processor communicatively coupled to a non-transitory, computer-readable storage medium. The non-transitory, computer-readable storage medium configured to store computer program instructions executable by the at least one processor. A rich message template management application (RMTMA) defining the computer program instructions, which when executed by the at least one processor, cause the at least one processor to execute steps comprising: sending a request for the test template comprising a test message to a specific number, wherein the test template comprising the test message is specific to a communication provider; checking to ensure that the specific number is registered to receive the test template comprising the test message; and calling an application programming interface (API) to send the test template comprising the test message, wherein the API allows sending of the test template comprising the test message, and optionally, allows the test message to bypass any business rules that limit number of messages, and wherein sending the test template comprising the test message is not counted towards a limit for the number of messages.

In another embodiment, a method for sending a test template is provided. The method comprises: providing a rich message template management application (RMTMA) in a non-transitory, computer-readable storage medium communicatively coupled to at least one processor. The non-transitory, computer-readable storage medium is configured to store computer program instructions executable by the at least one processor, and wherein said computer program instructions, when executed by the at least one processor, cause the at least one processor to execute steps comprising: sending a request for the test template comprising a test message to a specific number, wherein the test template comprising the test message is specific to a communication provider; checking to ensure that the specific number is registered to receive the test template comprising the test message; and calling an application programming interface (API) to send the test template comprising the test message, wherein the API allows sending of the test template comprising the test message, and optionally, allows to bypass any business rules that limit number of messages, and wherein sending the test template comprising the test message is not counted towards a limit for the number of messages.

In another embodiment, a system for sending a test template is provided. The system comprises: at least one processor communicatively coupled to a non-transitory, computer-readable storage medium; said non-transitory, computer-readable storage medium configured to store computer program instructions executable by the at least one processor; a rich message template management application (RMTMA) defining said computer program instructions, which when executed by the at least one processor, cause the at least one processor to execute steps comprising: creating the test template comprising a test message, wherein the test template comprising the test message is specific to a communication provider; sending the test template comprising the test message to a user; receiving a response message from the user using the test template; sending a person-to-application (P2A) link or a QR code to the user; and initiating a P2A conversation by the user, by clicking the P2A link or by scanning the QR code.

In another embodiment, a method for sending a test template is provided. The method comprises: providing a rich message template management application (RMTMA) in a non-transitory, computer-readable storage medium communicatively coupled to at least one processor, wherein said non-transitory, computer-readable storage medium is configured to store computer program instructions executable by the at least one processor, and wherein said computer program instructions, when executed by the at least one processor, cause the at least one processor to execute steps comprising: creating the test template comprising a test message, wherein the test template comprising the test message is specific to a communication provider; sending the test template comprising the test message to a user; receiving a response message from the user using the test template; sending a person-to-application (P2A) link or a QR code to the user; and initiating a P2A conversation by the user, by clicking the P2A link or by scanning the QR code. For example, a P2A URL link is sent to a user, allowing the user to click and initiate a chat with a rich communication services (RCS) agent to be tested. By sending a P2A message, the user initiates a 24 hour test session during which all messages, including messages from templates being tested, can be sent to the user.

In another embodiment, a system for sending a test template is provided. The system comprises: at least one processor communicatively coupled to a non-transitory, computer-readable storage medium; said non-transitory, computer-readable storage medium configured to store computer program instructions executable by the at least one processor; a rich message template management application (RMTMA) defining said computer program instructions, which when executed by the at least one processor, cause the at least one processor to execute steps comprising: sending a request for the test template comprising a test message to a specific number, wherein the test template comprising the test message is specific to a communication provider; receiving the test template comprising the test message from the specific number; sending a person-to-application (P2A) link or a QR code to a user; initiating a P2A conversation by the user, by clicking the P2A link or by scanning the QR code; and sending the test template comprising the test message to the user.

In another embodiment, a method for sending a test template is provided. The method comprises: providing a rich message template management application (RMTMA) in a non-transitory, computer-readable storage medium communicatively coupled to at least one processor, wherein said non-transitory, computer-readable storage medium is configured to store computer program instructions executable by the at least one processor, and wherein said computer program instructions, when executed by the at least one processor, cause the at least one processor to execute steps comprising: sending a request for the test template comprising a test message to a specific number, wherein the test template comprising the test message is specific to a communication provider; receiving the test template comprising the test message from the specific number; sending a person-to-application (P2A) link or a QR code to a user; initiating a P2A conversation by the user, by clicking the P2A link or by scanning the QR code; and sending the test template comprising the test message to the user.

In another embodiment, a method for a communication platform as a service (CPaaS) Provider to test message templates is provided. The method employs a rich message template management application in a non-transitory, computer-readable storage medium communicatively coupled to at least one processor. The non-transitory, computer-readable storage medium is configured to store computer program instructions executable by the at least one processor. The computer program instructions, when executed by the at least one processor, cause the at least one processor to execute steps to test message templates. The CPaaS provider creates the message template on a communication provider's platform for sending the message to a tester, even when not engaged in a conversation, by a communication provider. The CPaaS provider permits a business user or developer to create the message template on the CPaaS provider's platform. The CPaaS provider sends a request to a communication provider's platform using a template management application programing interface (API) to create an equivalent template message on the communication provider's platform. A business user or developer adds a mobile station international subscriber directory number (MSISDN) of an intended recipient as a tester on the CPaaS provider's platform using an add tester feature on the CPaaS provider's platform. Furthermore, adding the MSISDN of the intended recipient as the tester on the communication provider's platform comprises a business user or a developer uses the add tester feature on a CPaaS provider's platform to add an intended recipient's MSISDN as a tester. A specific process is used to make the intended recipient as the tester depending on a messaging channel. For example, in rich communication services (RCS) channel the intended recipient's MSISDN will receive a tester invite, and the intended recipient becomes the tester upon accepting the tester invite.

The CPaaS provider sends a request to the communication provider's platform to send the message template to the intended recipient. The communication provider's platform verifies that the intended recipient is a valid tester. If the MSISDN is a valid tester, the communication provider's platform retrieves a definition of the message template based on the unique template ID, the sender ID, and values of custom variables. The communication provider's platform expands the message template into an underlying rich message for a channel and sends it to the intended recipient or to another communication provider's platform using the send test message API. The input parameters of the send test message API comprises the MSISDN of the intended recipient. The CPaaS provider receives a confirmation from the intended recipient that the template message is as per expectation.

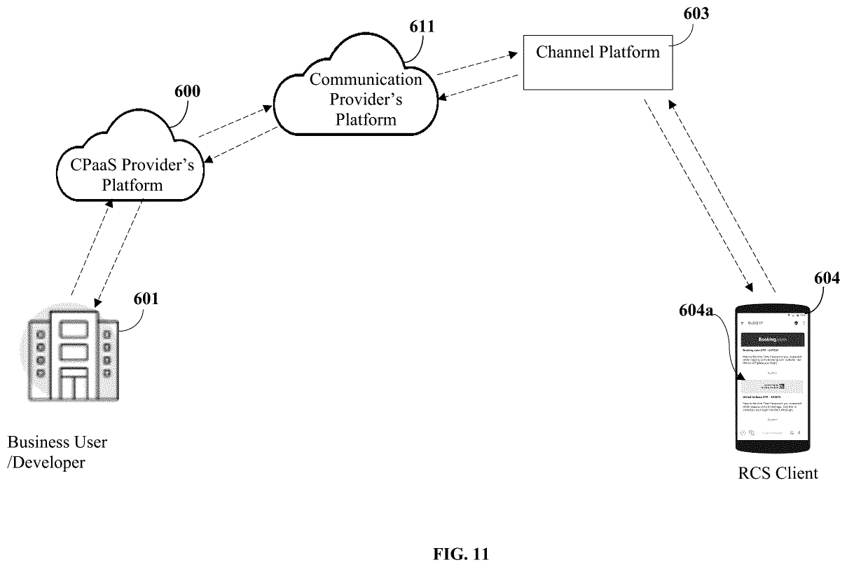

FIG. 11 exemplarily illustrates a schematic showing a process flow of an embodiment of the method for communication platform as a service (CPaaS) Provider to test a message template on a CPaaS Provider's platform via rich communication services (RCS) channel. The method employs a rich message template management application (RMTMA) comprising at least one processor communicatively coupled to a non-transitory computer-readable storage medium. The non-transitory computer-readable storage medium is configured to store computer program instructions executable by the at least one processor. A communication provider defines a “Test Template” application programming interface (“Test Template API”). The CPaaS provider permits a business user or developer 601 to create the message template on the CPaaS provider's platform 600. The CPaaS provider creates an equivalent template message on the communication provider's platform 611. The business user or developer 601 adds a Mobile Station International Subscriber Directory Number (MSISDN) of a user (intended recipient) as a tester on the CPaaS provider's platform 600, using an add tester feature on the CPaaS Provider's platform 600. The business user or developer 601 selects the created message template—and testing the selected message template by specifying the MSISDN of the intended recipient. The CPaaS Provider's platform 600 allows the business user or developer 601 to select and test the message template.

The CPaaS provider's platform 600 sends a request to the communication provider's platform 611 to send the message template, using the “Test Template” API. The communication provider's platform 611 receives the request to “Test Template”. The communication provider's platform 611 verifies the MSISDN specified in the request as a valid Tester. If the MSISDN is a valid tester, the communication provider's platform 611 retrieves the definition of the message template based on the unique template ID, sender ID, and using optional values of custom variables, expands the message template into the underlying rich message for a rich communication services (RCS) channel, and sends it to the user via channel platform 603 using an underlying “Send Message” API of the channel platform 603. The channel platform 604 comprises a RCS Channel Platform, a WhatsApp channel platform, a Viber channel platform, etc. The intended recipient receives the message template on a RCS client 604a on a user device 604. The intended recipient tests and confirms that the message template is as per expectation.

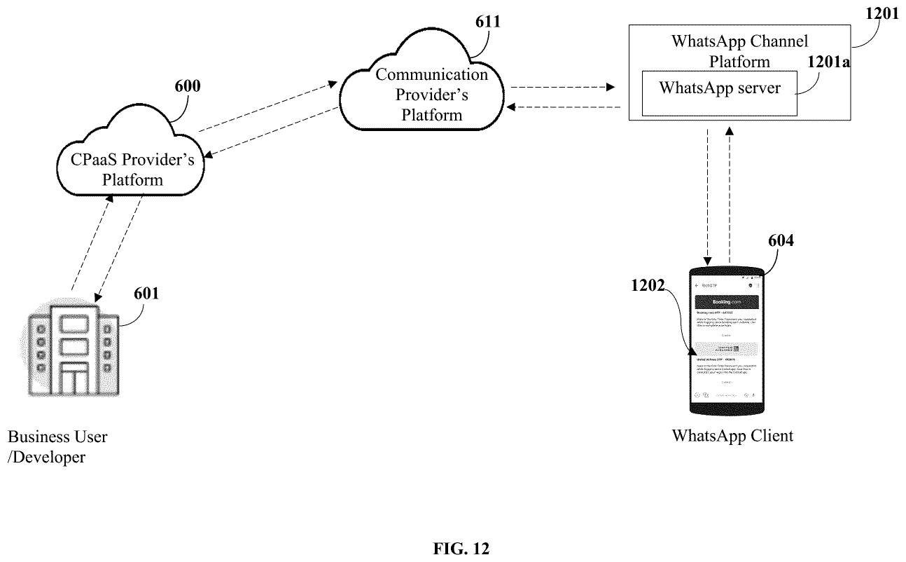

FIG. 12 exemplarily illustrates a schematic showing a process flow of an embodiment of the method for communication platform as a service (CPaaS) Provider to test a message template on a CPaaS Provider's platform via WhatsApp. The method employs a rich message template management application (RMTMA) comprising at least one processor communicatively coupled to a non-transitory computer-readable storage medium. The non-transitory computer-readable storage medium is configured to store computer program instructions executable by the at least one processor. A communication provider defines a “Test Template” application programming interface (“Test Template API”). The CPaaS provider permits a business user or developer 601 to create the message template on the CPaaS provider's platform 600. The CPaaS provider creates an equivalent template message on the communication provider's platform 611. The business user or developer 601 adds a Mobile Station International Subscriber Directory Number (MSISDN) of a user (intended recipient) as a tester on the CPaaS provider's platform 600, using an add tester feature on the CPaaS provider's platform 600. The business user or developer 601 selects the created message template and testing the selected message template by specifying the MSISDN of the intended recipient. The CPaaS provider's platform 600 allows the business user or developer 601 to select and test the message template.

The CPaaS provider's platform 600 sends a request to the communication provider's platform 611 to send the message template, using the “Test Template API”. The communication provider's platform 611 receives the request to “Test Template”. The communication provider's platform 611 verifies the MSISDN specified in the request as a valid Tester. If the MSISDN is a valid tester, the communication provider's platform 611 retrieves the definition of the message template based on the unique template ID, sender ID, and using optional values of custom variables, expands the message template into the underlying rich message for a WhatsApp channel, and sends it to the user via WhatsApp channel platform 1201 using an underlying “Send Message” API for the WhatsApp channel platform 1201, and a WhatsApp server 1201a. The intended recipient receives the message template on a WhatsApp client 1202 on a user device 604. The intended recipient tests and confirms that the message template is as per expectation.

The foregoing examples have been provided merely for illustration and are in no way to be construed as limiting of the method disclosed herein. While the method has been described with reference to various embodiments, it is understood that the words, which have been used herein, are words of description and illustration, rather than words of limitation. Further, although the method have been described herein with reference to particular means, materials, and embodiments, the method are not intended to be limited to the particulars disclosed herein; rather, the method extend to all functionally equivalent structures, methods and uses, such as are within the scope of the appended claims. Those skilled in the art, having the benefit of the teachings of this specification, may effect numerous modifications thereto and changes may be made without departing from the scope of the method disclosed herein in their aspects.

We claim:

1. A method for a communication platform as a service (CPaaS) provider to test a message template, comprising:
providing a rich message template management application in a non-transitory, computer-readable storage medium communicatively coupled to at least one processor, wherein said non-transitory, computer-readable storage medium is configured to store computer program instructions executable by the at least one processor, and wherein said computer program instructions, when executed by the at least one processor, cause the at least one processor to execute steps comprising:
creating the message template on a communication provider's platform, by the CPaaS provider, wherein the created message template is tagged with a unique template ID and a sender ID;
adding a mobile station international subscriber directory number (MSISDN) of an intended recipient as a tester on the communication provider's platform;
sending a request to the communication provider's platform for sending a test template message to the intended recipient, using a send test template message application programming interface provided by the communication provider, wherein the communication provider's platform verifies that the intended recipient is a valid tester, wherein if the MSISDN is a valid tester, the communication provider's platform retrieves a definition of the message template based on the unique template ID, the sender ID, and values of custom variables, and wherein the communication provider's platform expands the message template to create the test template message into an underlying rich message for a channel and sends it to the intended recipient via a channel platform using a send message application programming interface of the channel platform; and
receiving a confirmation from the intended recipient that the test template message is as per expectation.

2. The method of claim 1, wherein adding the mobile station international subscriber directory number (MSISDN) of the intended recipient as the tester on the communication provider's platform comprises:
a business user or a developer using an add tester feature on a CPaaS provider's platform to add the intended recipient's MSISDN as the tester, wherein depending on a messaging channel, a specific process is used to make the intended recipient's MSISDN as the tester.

3. The method of claim 2, wherein for rich communication services channel, the intended recipient's MSISDN will receive a tester invite, and the intended recipient becomes the tester upon accepting the tester invite.

4. A system for testing a message template, comprising:
at least one processor communicatively coupled to a non-transitory, computer-readable storage medium;
said non-transitory, computer-readable storage medium configured to store computer program instructions executable by the at least one processor; and
a rich message template management application defining said computer program instructions, which when executed by the at least one processor, cause the at least one processor to:
create the message template on a communication provider's platform, by a communication platform as a service (CPaaS) provider, wherein the created message template is tagged with a unique template ID and a sender ID;
add a mobile station international subscriber directory number (MSISDN) of an intended recipient as a tester on the communication provider's platform;
send a request to the communication provider's platform for sending a test template message to the intended recipient, using a send test template message application programming interface provided by the communication provider, wherein the communication provider's platform verifies that the intended recipient is a valid tester, wherein if the MSISDN is a valid tester, the communication provider's platform retrieves a definition of the message template based on the unique template ID, the sender ID, and values of custom variables, and wherein the communication provider's platform expands the message template to create the test template message into an underlying rich message for a channel and sends it to the intended recipient via a channel platform using a send message application programming interface of the channel platform; and
receive a confirmation from the intended recipient that the test template message is as per expectation.

5. The system of claim 4, wherein addition of the mobile station international subscriber directory number (MSISDN) of the intended recipient as the tester on the communication provider's platform comprises:
a business user or a developer using an add tester feature on a CPaaS provider's platform to add the intended recipient's MSISDN as the tester, wherein depending on a messaging channel, a specific process is used to make the intended recipient's MSISDN as the tester.

6. The system of claim 5, wherein for rich communication services channel, the intended recipient's MSISDN will receive a tester invite, and the intended recipient becomes the tester upon accepting the tester invite.
